(19) United States
(12) Patent Application Publication
(10) Pub. No.: US 2026/0350172 A1
(43) Pub. Date: Nov. 5, 2026

(54) PORTABLE BOOT LOADER USING BLOCKCHAIN

(71) Applicant: nChain Licensing AG, Zug (CH)

(72) Inventors: Liuxuan PAN, London (GB); Wei ZHANG, London (GB); Craig WRIGHT, London (GB)

(21) Appl. No.: 19/487,984

(22) PCT Filed: May 29, 2024
(86) PCT No.: PCT/EP2024/064736

§ 371 Date: Nov. 25, 2025

(30) Foreign Application Priority Data
May 30, 2023 (GB) 2308053.4
May 30, 2023 (GB) 2308054.2
May 30, 2023 (GB) 2308056.7

(51) Int. Cl. G06F 21/57; H04L 9/00; H04L 9/32

(52) U.S. Cl. CPC G06F 21/575; H04L 9/3247; H04L 9/50; G06F 2221/034

(57) ABSTRACT

A computer-implemented method for booting a device using a portable boot loader device, wherein the portable boot loader device comprises a boot loader and operating system files, wherein a blockchain comprises a boot loader transaction, wherein the boot loader transaction comprises an output locked to a master public key, and wherein the boot loader transaction comprises a first signature signing the boot loader and a second signature signing the operating system files, and wherein the method comprises: obtaining the boot loader transaction; verifying the first signature using the master public key; verifying the second signature using the master public key; and loading the operating system files using the boot loader.

### CROSS REFERENCE TO RELATED APPLICATIONS

This application is the U.S. National Stage of International Application No. PCT/EP2024/064736 filed on May 29, 2024, which claims the benefit of United Kingdom Patent Application No. 2308053.4 filed on May 30, 2023, and United Kingdom Patent Application No. 2308054.2 filed on May 30, 2023, and United Kingdom Patent Application No. 2308056.7 filed on May 30, 2023, the contents of which are all incorporated herein by reference in their entireties.

### TECHNICAL FIELD

The present disclosure relates to methods for booting a device using a portable boot loader, wherein the method makes use of a blockchain, and to a portable boot loader device, such as a USB stick.

### BACKGROUND

Booting is an important process of starting a computing device, and includes initializing hardware components and/or loading an operating system into the device's memory. Typically the main hardware and software components of the device that support the booting process are:
ROM (read-only memory)—memory storing built-in programs;
RAM (random-access memory)—memory storing temporary files;
BIOS (Basic Input Output System)—a small set of instructions stored in the ROM;
CPU (Central Processing Unit)—executes all programs located in the ROM and RAM;
OSF (Operating System Files)—files that can be loaded from a hard disk or other hardware to RAM by the boot loader, and then executed by the CPU;
BL (Boot Loader)—a program used to load the (OSF) into the RAM;
Firmware—refers to any program that is tightly linked to hardware, including the BIOS.

A secure boot process is widely adopted in the computing industry to prevent unauthorized software from running on the computer, protecting the computer against various security threats, e.g., malware and viruses, and ensuring the integrity and security of the operating system. In short, the secure boot process allows a device to boot securely by implementing the software trusted by the original manufacturer. FIG. 3 illustrates an example of how a secure boot is executed in a computer, where:
PK_{BS} is a public key controlled by the manufacturer and used to verify the signature on the BIOS;
SIG_{BS} is a signature on the BIOS generated by the manufacturer using the private key with respect to PK_{BS};
PK_{BL} is a public key controlled by the manufacturer and used to verify the signature on the boot loader.
SIG_{BL} is a signature on the boot loader generated by the manufacturer using the private key with respect to PK_{BL}.

The secure boot process includes the following steps:
1. BIOS validation: when the power on signal is sent to the CPU, the CPU locates the BIOS and verifies SIG_{BS} using PK_{BS} to ensure that the BIOS has not been tampered with.
2. Boot loader validation: After passing the signature verification of the BIOS, the BIOS then checks SIG_{BL} against the public key PK_{BL} stored on the BIOS. If the boot loader is not signed or is signed by an untrusted authority, the secure boot process will prevent it from being loaded and executed on the computer.
3. Operating system validation: The boot loader then checks the digital signature of the OSF to verify that they have not been tampered with. If they are not signed or have been signed by an untrusted authority, the secure boot process will prevent them from being loaded to the RAM.
4. System initialization: If all of the signatures have been verified and all software is trusted, the operating system is loaded into the memory and initialized. Finally, the CPU can execute the operating system files to perform tasks for the user.

In the system initialization, the CPU may access the OSF using a file pointer. A file pointer is a data structure that represents a position within a file. It can be used to point to a specific position within the file when reading it. The file pointer has the following advantages.
Reading Data efficiently: The file pointer helps in determining the current position from where data is being read.
Access data sequentially: The file pointer allows data to be read sequentially from the beginning to the end of the file. This is useful when dealing with files that require data to be processed in a specific order.
Access data randomly: The file pointer allows data to be read at any desired position in the file. This is useful when dealing with large files or databases where data needs to be accessed or modified at specific positions without having to read the entire file.

### SUMMARY

With the rapid development of the Internet of Things (IoT) as well as the demand for privacy and data ownership, users are storing more and more sensitive data on their devices. Thus, these devices are more prone to attacks and each attack provides more information for further damage. To protect sensitive data, it is desirable for devices to be equipped with safe and trusted hardware that enables them to implement secure software and operating systems. In particular, they need a secure booting process to load trusted applications and software. The booting process is typically implemented by a boot loader, which is a special program allowing users to load an operating system into the memory. Roughly speaking, the boot loader runs before any other user applications stored in the memory.

Booting a device with an unsecure boot loader may make it easier to load an unsecure operating system. Thus, the device is susceptible to security threats that can result in data loss, theft of sensitive information, or unauthorized access.

Nowadays, the computing industry generally agrees to use a secure boot mechanism to prevent unauthorized software or operating systems from running on devices. Typically, devices are equipped with trusted hardware including a raw boot loader. The raw boot loader is generally stored on one of the hard disks in a device and signed by the Original Device Manufacturer (ODM). However, this makes it difficult for users to update the boot loader or boot a special system on the device.

For flexibility in meeting users' requirements, the boot loader can be stored in external sources such as a USB stick, SD Card, or an Ethernet-connected device. This requires such a boot loader to have a secure verification mechanism to ensure that no malicious code or malware can be added into the USB, etc., and/or its code can be verified and only updated from trusted sources.

There is therefore a need for a secure boot protocol using an external (i.e. portable) boot loader device.

According to one aspect disclosed herein, there is provided a computer-implemented method for booting a device using a portable boot loader device, wherein the portable boot loader device comprises a boot loader and operating system files, wherein a blockchain comprises a boot loader transaction, wherein the boot loader transaction comprises an output locked to a master public key, and wherein the boot loader transaction comprises a first signature signing the boot loader and a second signature signing the operating system files, and wherein the method comprises: obtaining the boot loader transaction; verifying the first signature using the master public key; verifying the second signature using the master public key; and loading the operating system files using the boot loader.

According to one aspect disclosed herein, there is provided a computer-implemented method for booting a device using a portable boot loader device, wherein the portable boot loader device comprises a boot loader and operating system files, and wherein the method comprises: submitting an initial boot loader transaction to a blockchain network, wherein the boot loader transaction comprises an output locked to a master public key, and wherein the boot loader transaction comprises a first signature signing the boot loader and a second signature signing the operating system files.

A portable boot loader (PBL) is defined herein as an external storage medium (e.g., CD/DVD, USB stick, external hard drive) storing a boot loader, that allows users to boot a device from the medium. A PBL may be needed if a device no longer starts itself because of a virus or a system failure. A PBL may also be used in the event of data backup of an operating system and/or to boot an operating system on one or more devices.

However, the external storage medium may make the boot loader vulnerable to some risks such as malware and virus infections, unauthorized software execution, data theft, or tampering. To mitigate these risks, embodiments of the present disclosure provide verification mechanisms that allow users to check the validity and data integrity of the portable boot loader by utilizing blockchain transactions. In addition, some embodiments allow the portable boot loader to be revoked, replaced, or updated from trusted sources (such as the blockchain), e.g. if the medium is lost, stolen or tampered with.

For simplicity, examples are described in terms of a personal computer as an example of device and a USB drive as an example of external source storing the portable boot loader. However it will be appreciated that in general any device may require booting and any other type of portable hardware or storage device may be used as a portable boot loader.

In some embodiments, the verification mechanism is built on top of the secure boot protocol described above and assumes all computers are equipped with BIOS. This allows the verification mechanism to be seamlessly integrated into the existing booting process. These embodiments make use of the existing process to download the boot loader and operating system into a USB drive.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 schematically illustrates an example of a secure boot protocol,

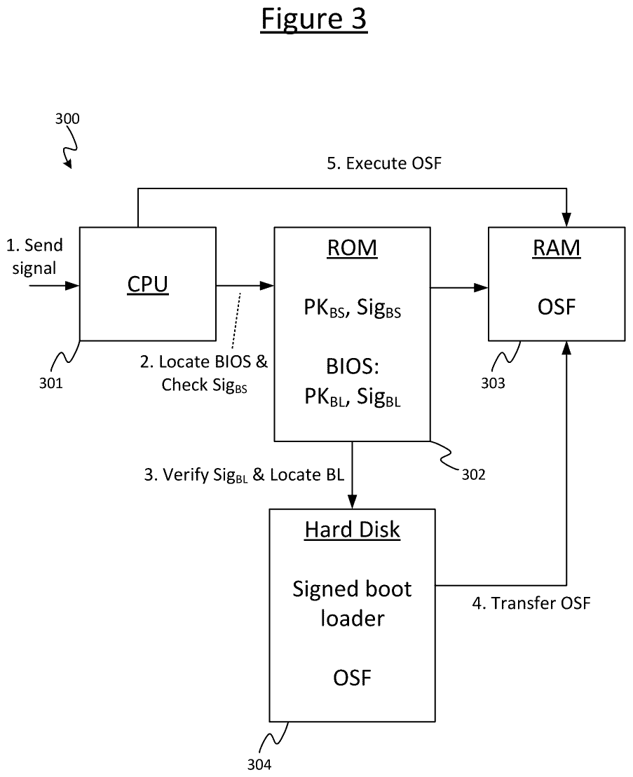

FIG. 4 schematically illustrates an example system for booting a device using a portable boot loader, and

FIG. 5 is a more detailed example of the system shown in FIG. 4.

### DETAILED DESCRIPTION OF EMBODIMENTS

### 1. Portable Boot Loader

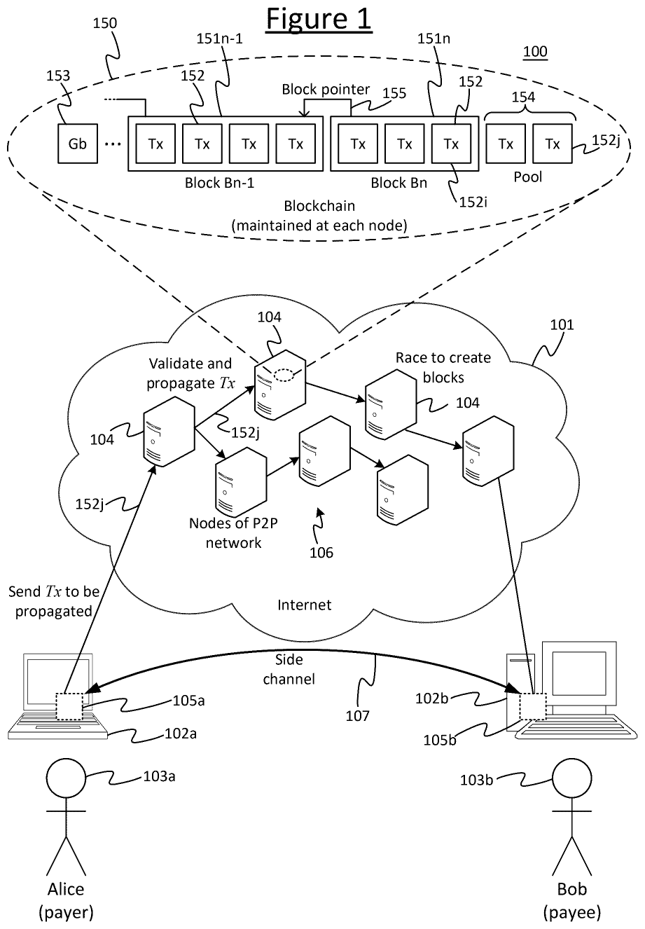

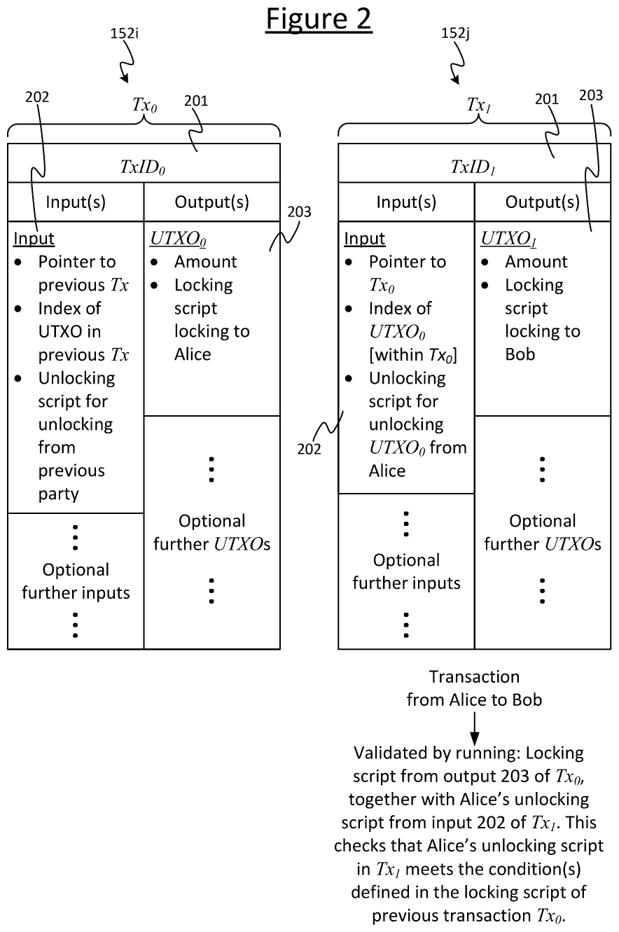

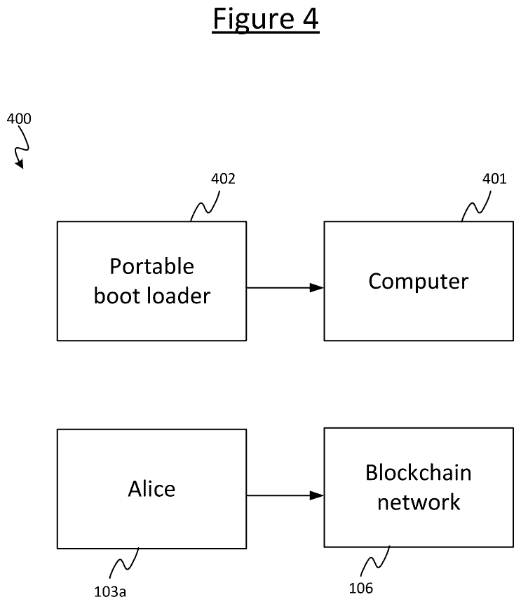

FIG. 4 illustrates an example system 400 for booting a device 401 using a portable boot loader 402. In general, the device 401 may be any type of computing device that runs an operating system. For example, the device 401 may be a desktop or laptop computer, a mobile device such as a mobile phone or tablet, an IoT device such as a sensor, and so on. The portable boot loader 402 may be any portable storage device such as a USB drive, a CD or DVD, a portable hard drive, a flash drive, a memory card, etc. In some examples, the portable storge device 402 may be a smartphone, a tablet, a laptop, etc. The system 400 also includes a user 103a. For convenience the user 103a will be referred to as Alice 103a. In general, the user 103a may be configured to perform any action described below as being performed by Alice 103a and/or Bob 103b with reference to FIGS. 1 and 2. The system 400 also includes one or more blockchain nodes 104 of a blockchain network 106.

In some embodiments, the portable boot loader (PBL) 402 has stored thereon operating system files and a boot loader configured to load the operating system files to memory of the device. The PBL 402 also has stored thereon Alice's public key (i.e., a public key corresponding to a private key owned by (i.e., accessible by) Alice 103a). Also stored on the PBL 402 are two signatures. A first signature signs a message comprising the boot loader. The first signature is generated using Alice's private key associated with a public key that has been certified using a master public key. The master public key is owned by a trusted third party, such as a certificate authority (i.e., an authority trusted to issue certificates for public keys) or a manufacturer of the device 401. The master public key is stored on the device 401. A certificate for Alice's certified public key is also stored on the PBL 402. A second signature signs a message comprising the operating system files and is generated using a private key associated with Alice's public key or a trusted public key, e.g., the certificate authority's public key, the device manufacturer's public key, or the issuer of the operating system files. A transaction identifier (TxID) of a blockchain transaction (a “boot loader transaction”) is also stored on the PBL 402. The transaction, which is recorded on the blockchain 150, includes an output (e.g. a P2PK or P2PKH) output locked to the Alice's public key.

In these embodiments, when the PBL 402 is connected to the device 401 to boot the device 401 (e.g. by Alice 103a), the device 401 is configured to extract the certificate and the first and second signatures form the PBL 402. The device 401 verifies the extracted certificate using the master public key. That is, the device 401 verifies that the certificate has been signed with, or comprises, a signature generated using a private key corresponding to the master public key. The device 401 may also verify that the certificate certifies (i.e. has been issued for) Alice's public key. This may include verifying that the certificate comprises Alice's public key. The device 401 also verifies the first signature using Alice's public key and verifies the second signature using Alice's public key or the trusted public key. The skilled person is familiar with signature verification per se. If any verification fails, the device 401 aborts the boot operation.

If the verifications pass, the device 401 uses the TxID stored on the PBL 402 to obtain the boot loader transaction. For instance, the device 401 may obtain the boot loader transaction directly from the blockchain (e.g. by sending a request for the transaction to a blockchain node 104) or via a service provider. The device 401 verifies that the output of the boot loader transaction locked to Alice's public key is unspent, i.e. it has not been assigned. This may involve sending a request to a blockchain node 104 and/or the service provider for a status of the output. If so, the device 401 continues with the boot operation by loading the operating system files. If the output is spent, the device 401 aborts the boot operation. The output may be spent by a revocation transaction (e.g. submitted to the blockchain 150 by Alice 103a) to prevent the device 401 being booted using the boot loader and operating system files stored on the PBL 402.

In some examples, the boot loader transaction or the PBL 402 includes a file address (e.g. a pointer). The device 401 may use the file address to locate one or more files of the operating system files, and execute the located files.

The boot loader transaction may include a hash of the file address. The device 401 may hash the file address (obtained from the PBL 402 or the boot loader transaction) and compare the result with the hash stored in the boot loader transaction. In these examples the device 401 only locates and executes the files if the hashes match.

Similarly, the boot loader transaction may include a hash of the operating system files. The device 401 may hash the operating system files (obtained from the PBL 402) and compare the result with the hash stored in the boot loader transaction. In these examples the device 401 only load and/or execute the operating system files if the hashes match.

The boot loader transaction may be generated by Alice 103a or the owner of the master public key (e.g. the device manufacturer). The information stored on the PBL 402 may be stored by Alice 103a or the owner of the master public key (e.g. the device manufacturer).

In other embodiments, the PBL 402 has stored thereon operating system files and a boot loader configured to load the operating system files to memory of the device 401. A transaction identifier (TxID) of a blockchain transaction (a “boot loader transaction”) is stored on the PBL 402 or the device 401. The transaction, which is recorded on the blockchain 150, includes an output (e.g. a P2PK or P2PKH) locked to a master public key. The master public key is owned by a trusted third party, such as a certificate authority or a manufacturer of the device. The master public key is stored on the device 401 or the PBL 402. The boot loader transaction includes two signatures. A first signature signs a message comprising the boot loader and is generated using a master private key corresponding to the master public key. A second signature signs a message comprising the operating system files and is generated using the master private key.

In these embodiments, when the PBL 402 is connected to the device 401 to boot the device 401 (e.g. by Alice 103a), the device 401 is configured to use the TxID to obtain the boot loader transaction and extract the first and second signatures form the transaction. The Boot loader transaction may be obtained in any of the ways described above. The device 401 verifies the first and second signatures. If any verification fails, the device 401 aborts the boot operation. If the verifications pass, the device 401 extracts the boot loader and operating system files from the PBL 402 and uses the boot loader to load the operating system files.

In some examples, the boot loader transaction or the PBL 402 includes a file address (e.g. a pointer). The device 401 may use the file address to locate one or more files of the operating system files, and execute the located files.

In some examples, the TxID stored on the device 401 or PBL 402 is a transaction identifier of a transaction belonging to a chain of boot loader transactions starting from an initial boot loader transaction and ending in a final (or most recent) boot loader transaction. The device 401 may obtain one of the boot loader transactions (e.g. the initial boot loader transaction) using the stored TxID and determine that the output of the transaction locked to the master public key is spent (e.g. by querying a blockchain node 104 or storage service provider). The device 401 may then obtain the most recent boot loader transaction, and use the boot loader and operating system files stored in the most recent transaction to boot the device 401. The device 401 may also obtain a transaction chain proof (e.g. from a trusted service provider) to verify the most recent boot loader transaction is linked to the initial boot loader transaction on chain. This allows the boot loader and/or operating system files to be updated and for the device 401 to use the updated versions. In some examples, the TxID stored on the device 401 or PBL 402 is a transaction identifier of the initial boot loader transaction.

The boot loader transaction may be generated by Alice 103a or the owner of the master public key (e.g. the device manufacturer). The information stored on the PBL 402 may be stored by Alice 103a or the owner of the master public key (e.g. the device manufacturer). The owner of the master public key submits an initial boot loader transaction to the blockchain 150 that includes an initial boot loader and initial operation system files. The owner of the master public key may then submit an updated boot loader transaction to the blockchain 150 which spends an output of an initial boot loader transaction and comprises an updated boot loader and/or updated operating system files. The updated boot loader transaction includes an output locked to the master public key. This process of updating the boot loader and/or operating system files may be repeated one or more times.

In other embodiments, the PBL 402 has stored thereon a boot loader configured to load operating system files to memory of the device 401, wherein the operating system files are stored on the device 401. The PBL 402 also has stored thereon Alice's public key (i.e., a public key corresponding to a private key owned by (i.e., accessible by) Alice 103a). Also stored on the PBL 402 is a first signature that signs a message comprising the boot loader and generated using a private key corresponding to Alice's public key. A transaction identifier (TxID) of a blockchain transaction (a “boot loader transaction”) is also stored on the PBL 402. The transaction, which is recorded on the blockchain 150, comprises Alice's public key. For example, the boot loader transaction may include an output locked to Alice's public key.

In these embodiments, when the PBL 402 is connected to the device 401 to boot the device 401 (e.g. by Alice 103a), the device 401 is configured to use the TxID (extracted from the PBL 402) to obtain the boot loader transaction, e.g. via a blockchain node 104 or service provider. The device 401 verifies that Alice's public key stored on the PBL 402 matches the public key stored in the transaction. The device 401 also verifies the first signature using Alice's public key. If any verification fails, the device 401 aborts the boot operation. If the verifications pass, the device 401 extracts the boot loader from the PBL 402 and uses the boot loader to load the operating system files. In some examples the boot loader transaction and/or the PBL 402 stores a file address, and the device 401 uses the file address to locate one or more of the operating system files and execute said located files. Alternatively, the entire files may be executed.

In some examples, the operating system files are stored on the device 401 in an encrypted form. Any suitable form of encryption may be used. In this case, the device 401 first decrypts the files before loading them. For example, the files may be encrypted with Alice's public key and the device 401 may use Alice's private key to decrypt the files.

The device 401 may perform one or more additional checks before loading and/or executing the operating system files.

For example, the boot loader transaction may include a hash of the boot loader. The device 401 may hash the boot loader (obtained from the PBL 402) and compare the result with the hash stored in the boot loader transaction. In these examples the device 401 only loads and/or executes the operating system files if the hashes match.

Similarly, the boot loader transaction may include a hash of the operating system files. The device 401 may hash the operating system files (stored on the device 401) and compare the result with the hash stored in the boot loader transaction. In these examples the device 401 only load and/or execute the operating system files if the hashes match.

In examples where the boot loader transaction comprises an output locked to Alice's public key, the device 401 may verify that the output is unspent, e.g. by querying a blockchain node 104 or a service provider. In these examples the device 401 only load and/or execute the operating system files if the output is unspent.

The boot loader transaction may be generated by Alice 103a. The information stored on the PBL 402 may be stored by Alice 103a. Alice 103a may submit a transaction to the blockchain 150 that spends the output of the boot loader transaction so as to revoke the boot loader.

### 1.1 Example Mechanism 1—Public Key Infrastructure (PKI)

This section describes a specific example of how to verify the portable boot loader and the operating system stored in the portable boot loader.

### 1.1.1 Validation of a Portable Boot Loader

PK_{BL}, stored in BIOS by the device manufacturer, can be considered as the master public key for the boot loader. The manufacturer then authenticates trusted service providers to use PK_{BL} to certify a user's public key, PKᵤₛₑᵣ, and obtain a certificate Cert_{PK}_{ᵤₛₑᵣ}. The user then uses the certified public key PKᵤₛₑᵣ to sign the portable boot loader and obtain the corresponding signature SIG_{user-BL}. The certificate Cert_{PK}_{ᵤₛₑᵣ}, PKᵤₛₑᵣ and SIG_{user-BL} are stored in the USB drive. When the portable boot loader is plugged into a computer, the validated BIOS will check the validity of Cert_{PK}_{ᵤₛₑᵣ} using the PK_{BL}. If the Cert_{PK}_{ᵤₛₑᵣ} is valid, BIOS can trust PKᵤₛₑᵣ and use it to verify the SIG_{user-BL} on the portable boot loader. This ensures that the portable boot loader can be trusted. Another benefit is that the architecture of the existing BIOS does not require any changes.

PKᵤₛₑᵣ is also used in a blockchain transaction, as shown below in Table 1. This transaction is used in the validation of the operating system. In the locking script, the hash value of OSF, H(OSF), and a file pointer are included as a data payload, e.g. after an OP_RETURN opcode. This point address is related to a memory address which stores the loaded OSF on RAM. The output is fixed by the user, meaning it can only be spent by PKᵤₛₑᵣ. The output value may be set to a “dust” value x, which is the minimum amount accepted by blockchain nodes 104. When the transaction is published onto the blockchain 150, the user may submit the transaction identifier, TXID_{PBL}, as information related to the PKᵤₛₑᵣ, which is authenticated by the service provider.

TABLE 1
The portable boot loader transaction.
TXID_{PBL}

Output

| Input | Value | Locking script |
|---|---|---|
| UTXO | x | [P2PKH PKᵤₛₑᵣ] |
| | | OP_RETURN < H(OSF), file pointer > |

The hash value of the file pointer may instead be stored in the transaction, with the file pointer stored on the USB drive. Furthermore, the file pointer may be other types of data structure that the user can use to specify the position where in the OSF the CPU must read first.

### 1.1.2 Validation of Operating System

The USB drive contains some or all of the following information:

PKᵤₛₑᵣ, Cert_{PK}_{ᵤₛₑᵣ} and SIG_{user-BL};
BL—the boot loader;
OSF—the operating system files downloaded from a trusted service provider;
SIG_{user-OSF}—a signature on OSF, signed using the certified PKᵤₛₑᵣ or a trusted service provider's public key;
TXID_{PBL}.

The OSF validation mechanism is implemented as follows. The boot loader verifies SIG_{user-OSF} using PKᵤₛₑᵣ. If SIG_{user-OSF} is valid, then the boot loader loads the OSF to RAM. When the CPU wants to execute the OSF, it needs to locate the TXID_{PBL} first and requests a trusted service provider whether it is spent. If it is spent, the CPU will not execute the OSF and abort. If it is not spent, the CPU can extract the pointer address and H(OSF) from the TXID_{PBL}. The CPU uses the pointer address to locate the files on RAM. The CPU calculates the hash value of the located files and compares it with H(OSF). If it matches, then the CPU executes the located OSF. if it does not match, the computer aborts.

There are at least benefits of using TXID_{PBL} as part of the boot loader operation:
1. If the private key associated with the PKᵤₛₑᵣ is compromised, the user can spend the TXID_{PBL} to invalidate the PKᵤₛₑᵣ. This also can be applied to the case where the PBL USB drive is stolen. However, it is worth mentioning that the attacker can replace the TXID_{PBL} at any of their choice using the compromised PKᵤₛₑᵣ. This would allow the attacker to bypass the check on TXID_{PBL}. To avoid the replacement of TXID_{PBL}, the user can submit the TXID_{PBL} as the information for generating the Cert_{PK}_{ᵤₛₑᵣ} Thus, if TXID_{PBL} is replaced, it will invalidate Cert_{PK}_{ᵤₛₑᵣ}.
2. The H(OSF) in the TXID_{PBL} can be used to check whether the OSF loaded into RAM is the same as the target OSF. If it is not, the computer aborts.
3. The on-chain file pointer indicating the position in the OSF file where the CPU will execute is immutable. In other words, the CPU must execute specific position of the OSF specified by the user when it reads the OSF from RAM.

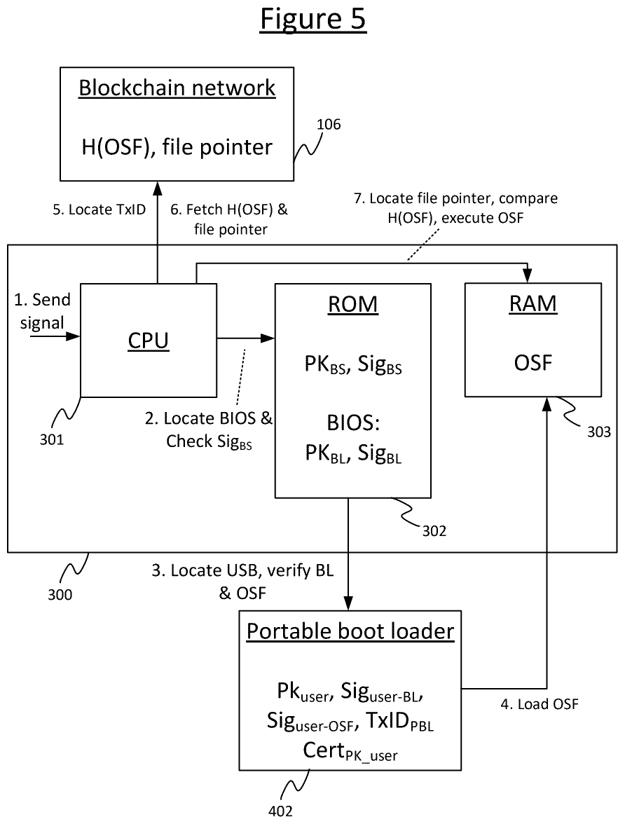

FIG. 5 provides an overview of how a portable boot loader boots an operating system according to this example.

### 1.2 Example Mechanism 2—Transaction ID on BIOS

This section describes a specific example of how to verify the portable boot loader and the operating system stored in the portable boot loader.

Compared to the PKI mechanism described above, the mechanism described in this section uses a blockchain transaction TXID_{BL} to store PK_{BL} and SIG_{BL}, instead of BIOS. The blockchain transaction TXID_{BL} (as shown in Table 2 below) is published by the manufacturer and contains an output that can only be spent by the manufacturer who is identified with the public key PK_{BL}. In the locking script, SIG_{BL} and SIG_{user-OSF} are included as a data payload, e.g. after an OP_RETURN opcode.

In this example the device 401 (e.g. computer) connects to the network to locate TXID_{BL} This may also be done by the service provider who the manufacturer can trust. This mechanism offers the flexibility for the manufacturer to update the boot loader and/or OSF without modifying BIOS. The manufacturer may publish a new blockchain transaction which spends the output of TXID_{BL} and pays to a new public key that links to the manufacturer, where the new transaction includes the updated boot loader and/or OSF. The BIOS checks whether the TXID_{BL} is spent. If not, it fetches the required information. If spent, it asks the trusted service provider to provide the latest UTXO that links to the TXID_{BL} and a transaction chain proof. Moreover, this example offers transparency to the user to check the status of the boot loader if it is updated by checking the spending status of TXID_{BL}.

TABLE 2
A blockchain transaction for storing PK_{BL}, SIG_{BL} and SIG_{OSF}.
TXID_{BL}

| | Output | |
|---|---|---|
| Input | Value | Locking script |
| UTXO | x | [P2PK PK_{BL}] OP_RETURN < SIG_{BL}, SIG_{OSF} > |

### 1.2.1 Validation

With this mechanism, the USB drive needs only store the boot loader and OSF. When PBL USB drive is plugged into the computer, the valid BIOS connects to the network 106 to locate TXID_{BL} and capture PK_{BL}, SIG_{BL} and SIG_{OSF} from the transaction. If the TXID_{BL} is spent, the BIOS asks the trusted service provider to locate the latest unspent transaction related to TXID_{BL}'s spending chain, and provide the transaction chain proof for verification. This allows the user to capture the latest public key and signatures on the updated boot loader and OSF. PK_{BL} is used to verify SIG_{BL} and SIG_{OSF}, ensuring the USB-stored BL and OSF are not tampered with. If all the signatures are valid, then the BL and OSF can be trusted. The OSF then is loaded into RAM.

Compared with the PKI solution, the TXID-based solution reduces the size of data stored on the USB drive. Also, the manufacturer can easily update the boot loader. The user can determine the updated status of the boot loader, and boot the OSF on any computer devices using the USB drive.

### 1.3 Discussion on Security and Limitations

The characteristic of portability provides the flexibility for the user to boot a device 401 or load an operating system on other devices. However, this makes it more vulnerable to the risk of theft, loss or tampering.

The verification mechanisms described above can be used to mitigate the risk, even if the portable boot loader is stolen and tampered with. The PKI or TXID solution ensures that the boot loader is trusted. Moreover, the blockchain transaction may include the hash values of the PBL and OSF. Due to the immutability of the blockchain, any tampering with the PBL USB drive by a non-original user will result in a hash match or signature verification failure. Furthermore, the verification mechanisms ensure that a fake portable boot loader created by a malicious actor cannot be implemented as the BIOS checks for validity before executing the boot loader.

### 1.4 Dedicated Portable Boot Loader

Usually, the boot loader is designed by the trusted manufacturer and is associated with the operating system. This section describes an example where a user can create a portable boot loader for a dedicated special operating system. The operating system may be encrypted and stored on the computer's hard disk. This allows for the operating system to boot using a dedicated boot loader. A blockchain transaction TXID_{PBL} is published onto the blockchain. A network address used to locate the transaction TXID_{PBL} may be stored on the hard disk.

The PBL USB drive contains some or all of the following information:
BL—the boot loader designed by the user and stored on the USB drive.
H(PBL)—the hash value of the BL.
PK_{PBL}—a public key generated by the user.
SIG_{H(PBL)}—a signature on H(PBL), which is signed by the user with the private key Priv_{PBL}.
TXID_{PBL}—a transaction ID.

The verification mechanism is implemented as follows:

BIOS may start its work of BIOS validation as described above. After passing the BIOS validation, BIOS detects the hard disk, finds the network address and connects to the network address to locate the TXID_{PBL}. If the connection fails, an error message is returned and the BL is not executed. A check is performed to determine whether the located TXID_{PBL} is equal to the transaction ID stored in the USB drive. If yes, then the CPU continues to the next step. If no, it pauses and returns the error message. PK_{PBL}, H(PBL), H(OSF) are extracted from the locking script of TXID_{PBL}. A check is preformed to determine whether the fetched public key and hash value are equal to the ones stored in the USB drive. If yes, the CPU continues verifying the stored signature SIG_{H(PBL)} against PK_{PBL} and PBL. If the stored signature is valid, the boot loader locates the encrypted OSF from the hard disk. The OSF is decrypted. If the decryption fails, the boot process will stop and return an error message. The hash value of the decrypted OSF is calculated and compared with H(OSF) captured from TXID_{PBL}. If it matches, the OSF is transferred to RAM.

The portability allows the user to easily update the boot loader. Moreover, the user can use the blockchain transaction to check the data integrity of the portable boot loader. If it is tampered with, then the user will not plug it into the target computer to boot the dedicated operating system. To sum up, if a malicious actor wants to gain access to the dedicated operating system, they need to obtain the portable boot loader, the target computer and the decryption key associated with the dedicated operating system, increasing security.

### 2. Operating a Device

Some embodiments of the present disclosure relate to the operating of a device using a blockchain (or at least based on data stored on the blockchain) 150. The device may take any form, e.g. computer equipment 102. In some examples, the device is a mobile device, such as a mobile phone or tablet.

A blockchain transaction (referred to below as a “data transaction” is created and sent to the blockchain 150. The data transaction comprises data (also referred to as a data item) that will be used to operate the device, or at least influence the operation of the device. For example, the data item may cause the device to be loaded or “booted” (similar to the embodiments described above). For example, the data item may comprise a bootloader, or cause (i.e. trigger) the device to obtain and/or execute a bootloader (stored on the device or elsewhere). Or, the data item may cause the device to update, e.g. one or more software modules of the device. For example, the data item may comprise the update to be executed, or cause (i.e. trigger) the device to obtain and/or execute one or more updates (stored on the device or elsewhere).

The data transaction may be created and/or submitted to the blockchain 150 by any one of: a manufacturer or seller of the device, a user of the device, a creator or seller of the data item (e.g. a software company).

A reference to the data transaction is stored on the device. For example, the reference may be a transaction identifier (TxID) of the data transaction. Any suitable reference may be used, such as a block height of a block containing the data transaction, along with an index of the transaction within that block. If the data transaction contains a public key, or public key hash, that may be used as the reference.

The device is configured to use the reference to obtain the data transaction, e.g. by sending a request to a blockchain node 104 for the data transaction, or by searching the blockchain 150 for the data transaction. The device may be configured to obtain the data transaction when switched on (or after a particular period of the device being in use), or when a particular operation is performed on the device (e.g. by a user of the device), or at a particular time and/or date.

The reference to the data transaction may be stored in hardware of the device, e.g. on a CPU of the device. The reference may be stored in secure hardware of the device, such as a secure enclave or trusted execution environment. In some examples, the reference may be stored on a (Subscriber Identity Module) SIM card of a mobile device.

Upon obtaining the data transaction, the device is configured to operate based on the data item. That is, the device extracts the data item from the data transaction and operates (i.e. performs an operation) based on that data item. For example, and as mentioned above, the operation may be a boot operation, or the loading of a program, or the update of a program or software module.

The data item, stored in the data transaction, may be encrypted. The device may be configured to decrypt the data item. The necessary decryption key may be stored on the device, e.g. in the secure hardware of the device.

In some examples, the device may be determine that a second data transaction is stored on the blockchain 150 that references the first data transaction. The second data transaction comprises a second data item. In this case, the device may be configured to obtain the second data transaction, extract the second data item and operate based on the second data item, e.g. to perform an additional update operation.

### 3. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicized. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialize in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorize (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 4. UTXO-Based Model

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 5. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

### Statements—Set A

Statement 1. A computer-implemented method for booting a device using a portable boot loader device, wherein the portable boot loader device comprises a boot loader and operating system files, wherein a blockchain comprises a boot loader transaction, wherein the boot loader transaction comprises an output locked to a master public key, and wherein the boot loader transaction comprises a first signature signing the boot loader and a second signature signing the operating system files, and wherein the method comprises:
obtaining the boot loader transaction;
verifying the first signature using the master public key;
verifying the second signature using the master public key; and
loading the operating system files using the boot loader.

Statement 2. The method of statement 1, wherein the boot loader transaction or the boot loader device comprises a file address, and wherein the method comprises using the file address to locate one or more files of the operating system files.

Statement 3. The method of statement 2, comprising executing the located one or more files.

Statement 4. The method of any of statements 1 to 3, wherein the boot loader transaction is a most recent boot loader transaction in a chain of respective boot loader transactions linking back to an initial boot loader transaction, wherein each respective boot loader transaction comprises an output locked to a respective master public key, and wherein said obtaining of the boot loader transaction comprises:
obtaining a boot loader transaction other than the most recent boot loader transaction;
determining that the output of the obtained boot loader transaction is spent; and
in response, obtaining the most recent boot loader transaction.

Statement 5. The method of statement 4, comprising:
obtaining a transaction chain proof for the most recent boot loader transaction, wherein the transaction chain proof provides proof that the most recent boot loader transaction is linked to the initial boot loader transaction; and
using the transaction chain proof to verify that the most recent boot loader transaction is linked to the initial boot loader transaction.

Statement 6. The method of any preceding statement, wherein said obtaining of the boot loader transaction comprises requesting the boot loader from a trusted party.

Statement 7. The method of any of statements 1 to 5, wherein the boot loader transaction is stored on the device.

Statement 8. A computer-implemented method for booting a device using a portable boot loader device, wherein the portable boot loader device comprises a boot loader and operating system files, and wherein the method comprises:
submitting an initial boot loader transaction to a blockchain network, wherein the boot loader transaction comprises an output locked to a master public key, and wherein the boot loader transaction comprises a first signature signing the boot loader and a second signature signing the operating system files.

The method of statement 8 may be a method of creating a portable bootloader for booting a device.

Statement 9. The method of statement 8, wherein the first signature is verifiable using the master public key; and
wherein the second signature is verifiable using the master public key.

Statement 10. The method of statement 8, wherein the initial boot loader transaction comprises a file address for locating one or more files of the operating system files.

Statement 11. The method of statement 8 or statement 9, comprising:
submitting an updated boot loader transaction to the blockchain network, wherein the updated boot loader transaction spends the output of the initial boot loader transaction and comprises an output locked to a respective master public key, wherein the updated boot loader transaction comprises an updated boot loader and/or updated operating system files.

Statement 12. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 11.

Statement 13. A computer program embodied on computer-readable storage and configured so as, when run on one or more processors, to perform the method of any of statements 1 to 11.

### Statements—Set B

Statement 1. A computer-implemented method for booting a device using a portable boot loader device, wherein the portable boot loader device comprises: a boot loader, operating system files, a user public key, a certificate certifying the user public key, a first signature signing the boot loader, a second signature signing the operating system files, and a transaction identifier of a boot loader transaction, wherein the boot loader transaction is a blockchain transaction comprising an output locked to the user public key and wherein the method comprises:
verifying the certificate using a master public key stored on the device;
verifying the first signature using the user public key;
verifying the second signature using the user public key or a trusted public key; and
obtaining a boot loader transaction using the transaction identifier, wherein a condition for loading the operating system files is that the output of the boot loader transaction is unspent.

Statement 2. The method of statement 1, comprising loading the operating system files using the boot loader.

Statement 3. The method of statement 1 or statement 2, wherein the boot loader transaction comprises a file address, and wherein the method comprises using the file address to locate one or more files of the operating system files.

Statement 4. The method of statement 1 or statement 2, wherein the portable boot loader device comprises a file address, and wherein the method comprises using the file address to locate one or more files of the operating system files.

Statement 5. The method of statement 4, wherein the boot loader transaction comprises a hash of the file address, and wherein the method comprises:
hashing the file address to obtain a first hash value; and
comparing the first hash value with the hash of the file address, wherein a condition for locating the one or more files is that the first hash value matches the hash of the file address.

Statement 6. The method of any of statements 2 to 5, comprising executing the located one or more files.

Statement 7. The method of statement 6, wherein the boot loader transaction comprises a hash of the operating system files, and wherein the method comprises:
hashing the operating system files to obtain a second hash value; and
comparing the second hash value with the hash of the operating system files, wherein a condition for executing the located one or more files is that the second hash value matches the hash of the operating system files.

Statement 8. The method of any preceding statement, comprising:
requesting, from a trusted party, a status of the output of the boot loader transaction.

Statement 9. The method of any preceding statement, wherein said verifying of the certificate using a master public key stored on the device and/or said verifying of the first signature using the user public key is performed by a Basic Input Output System (BIOS) of the device.

Statement 10. The method of any preceding statement, wherein the certificate comprises or is generated based on a transaction identifier of the bootloader transaction.

Statement 11. A method for booting a device using a portable boot loader device, comprising:
submitting a boot loader transaction to a blockchain network, wherein the boot loader transaction is a blockchain transaction comprising an output locked to a user public key;
storing, on the portable boot loader device, a boot loader, operating system files, the user public key, a certificate certifying the user public key, and a first signature signing the boot loader, a second signature signing the operating system files, and a transaction identifier of the boot loader transaction.

The method of statement 11 may be a method for creating a portable boot loader device for booting a device.

Statement 12. The method of statement 11, comprising storing, on the portable boot loader device, a master public key,
wherein the certificate is verifiable using the master public key,
wherein the first and second signatures are verifiable using the user public key, and
wherein the boot loader transaction is verifiable using the user public key.

Statement 13. The method of statement 12, wherein the second signature is verifiable using a trusted public key.

Statement 14. The method of statement 11, comprising using the boot loader to boot the device.

Statement 15. The method of any of statements 11 to 14, comprising submitting a revocation transaction to the blockchain network, wherein the revocation transaction spends the output of the boot loader transaction.

Statement 16. The method of any of statements 11 to 15, wherein the portable boot loader device comprises a file address or wherein the boot loader transaction comprises the file address.

Statement 17. The method of statement 16, wherein the boot loader transaction comprises a hash of the file address.

Statement 18. The method of any of statements 11 to 17, wherein the boot loader transaction comprises a hash of the operating system files.

Statement 19. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 18.

Statement 20. A computer program embodied on computer-readable storage and configured so as, when run on one or more processors, to perform the method of any of statements 1 to 18.

Statement 21. A computer-readable storage medium having stored thereon a boot loader, operating system files, a user public key, a certificate certifying the user public key, and a first signature signing the boot loader, a second signature signing the operating system files, and a transaction identifier of a boot loader transaction, wherein the boot loader transaction is a blockchain transaction comprising an output locked to the user public key.

Statement 22. The computer-readable storage media of statement 21, wherein the first and second signatures are verifiable using the user public key.

### Statements—Set C

Statement 1. A computer-implemented method for booting a device using a portable boot loader device, wherein the device comprises operating system files, wherein the portable boot loader device comprises a boot loader, a user public key, a first signature signing the boot loader, and a transaction identifier of a boot loader transaction, wherein a blockchain comprises the boot loader transaction, wherein the boot loader transaction comprises a candidate user public key, and wherein the method comprises:
obtaining the boot loader transaction using the transaction identifier;
verifying the candidate user public key corresponds to the user public key;
verifying the first signature using the user public key; and
   loading the operating system files using the boot loader.

Statement 2. The method of statement 1, wherein the boot loader transaction comprises a hash of the boot loader, and wherein the method comprises:
hashing the boot loader to obtain a first hash value; and
comparing the first hash value with the hash of the boot loader, wherein a condition for loading the operating system files is that the first hash value matches the hash of the boot loader.

Statement 3. The method of statement 1 or statement 2, wherein the boot loader transaction comprises a hash of the operating system files, and wherein the method comprises:
hashing the operating system files to obtain a second hash value; and
wherein a condition for loading and/or executing the operating system files is that the second hash value matches the hash of the operating system files.

Statement 4. The method of any preceding statement, wherein the operating system files are encrypted, and wherein the method comprises decrypting the operating system files.

Statement 5. The method of any preceding statement, wherein the boot loader transaction is a blockchain transaction comprising an output locked to the user public key, and wherein a condition for loading the operating system files is that the output of the boot loader transaction is unspent.

Statement 6. The method of any preceding statement, wherein the boot loader transaction comprises a file address, and wherein the method comprises:
using the file address to locate one or more files of the operating system files.

Statement 7. The method of any of statements 1 to 5, wherein the portable boot loader device comprises a file address, and wherein the method comprises:
using the file address to locate one or more files of the operating system files.

Statement 8. The method of statement 7, wherein the boot loader transaction comprises a hash of the file address, and wherein the method comprises:
hashing the file address to obtain a third hash value; and
comparing the third hash value with the hash of the file address, wherein a condition for loading and/or executing the operating system files is that the third hash value matches the hash of the file address.

Statement 9. The method of any of statements 6 to 8, comprising executing the located one or more files.

Statement 10. A method for booting a device using a portable boot loader device, comprising:
submitting a boot loader transaction to a blockchain network, wherein the boot loader transaction is a blockchain transaction comprising a user public key;
   storing, on the portable boot loader device, a boot loader, the user public key, a first signature signing the boot loader, and a transaction identifier of the boot loader transaction.

The method of statement 10 may be a method for creating a boot loader device for booting a device.

Statement 11. The method of statement 10, wherein the first signature is verifiable using the user public key.

Statement 12. The method of statement 11, comprising using the boot loader to boot the device.

Statement 13. The method of any of statements 10 to 12, wherein the bootloader transaction comprises an output locked to the user public key.

Statement 14. The method of statement 13, comprising submitting a revocation transaction to the blockchain network, wherein the revocation transaction spends the output of the boot loader transaction.

Statement 15. The method of any of statements 10 to 14, wherein the boot loader transaction comprises a hash of the boot loader and/or a hash of the operating system files.

Statement 16. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 15.

Statement 17. A computer program embodied on computer-readable storage and configured so as, when run on one or more processors, to perform the method of any of statements 1 to 15.

Statement 18. A computer-readable storage medium having stored thereon a boot loader, a user public key, a first signature signing the boot loader, and a transaction identifier of a boot loader transaction, wherein the boot loader transaction is a blockchain transaction comprising the user public key.

Statement 19. The computer-readable storage medium of statement 18, wherein the first signature is verifiable using the user public key.

### Statements—Set D

Statement 1. A computer-implemented method of operating a device using a blockchain, wherein the blockchain comprises a first blockchain transaction, the first blockchain transaction comprising first data, wherein a reference to a first blockchain transaction is stored on the device, and wherein the method comprises:
using the reference to obtain the first blockchain transaction; and
operating the device based on the first data.

Statement 2. The method of statement 1, comprising:
determining that the blockchain comprises a second blockchain transaction that references the first blockchain transaction, wherein the second blockchain transaction comprises second data; and
operating the device based on the second update data.

Statement 3. The method of statement 1 or statement 2, wherein operating the device comprises booting the device.

Statement 4. The method of statement 1 or statement 2, wherein operating the device comprises updating the device.

Statement 5. The method of any preceding statement, wherein the first and/or second data is encrypted, and wherein the method comprises decrypting the first and/or second data prior to operating the device.

Statement 6. The method of any preceding statement, wherein the reference is stored in hardware of the device.

Statement 7. A computer-implemented method of enabling a device to be operated using a device, comprising:
causing a first blockchain transaction to be submitted to a blockchain network, wherein the first blockchain transaction comprises first data, the device being configured to operate based on the first data;
storing a reference to the first blockchain transaction on the device.

Statement 8. The method of statement 7, comprising:
causing a second blockchain transaction to be submitted to the blockchain network, wherein the second blockchain transaction references the first blockchain transaction and comprises second data, the device being configured to operate based on the second data.

Statement 9. A device comprising a reference to a first blockchain transaction, wherein the first blockchain transaction comprises first data, and wherein the device is configured to:
use the reference to obtain the first blockchain transaction; and
operate based on the first data.

Statement 10. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 9.

Statement 11. A computer program embodied on computer-readable storage and configured so as, when run on one or more processors, to perform the method of any of statements 1 to 9.

1. A computer-implemented method for booting a device using a portable boot loader device comprising a boot loader and operating system files, and wherein the method comprises:
obtaining, from a blockchain, a boot loader transaction comprising an output locked to a master public key, a first signature signing the boot loader, and a second signature signing the operating system files;
verifying the first signature using the master public key;
verifying the second signature using the master public key; and
loading the operating system files using the boot loader.

2. The method of claim 1, wherein the boot loader transaction or the boot loader device comprises a file address, and wherein the method comprises using the file address to locate one or more files of the operating system files.

3. The method of claim 2, comprising executing the located one or more files.

4. The method of claim 1, wherein the boot loader transaction is a most recent boot loader transaction in a chain of respective boot loader transactions linking back to an initial boot loader transaction, wherein each respective boot loader transaction comprises an output locked to a respective master public key, and wherein said obtaining of the boot loader transaction comprises:
obtaining a boot loader transaction other than the most recent boot loader transaction;
determining that the output of the obtained boot loader transaction is spent; and
in response, obtaining the most recent boot loader transaction.

5. The method of claim 4, comprising:
obtaining a transaction chain proof for the most recent boot loader transaction, wherein the transaction chain proof provides proof that the most recent boot loader transaction is linked to the initial boot loader transaction; and
using the transaction chain proof to verify that the most recent boot loader transaction is linked to the initial boot loader transaction.

6. The method of claim 1, wherein said obtaining of the boot loader transaction comprises requesting the boot loader from a trusted party.

7. The method of claim 1, wherein the boot loader transaction is stored on the device.

8. A computer-implemented method for enabling booting of a device using a portable boot loader device, wherein the portable boot loader device comprises a boot loader and operating system files, and wherein the method comprises:
submitting an initial boot loader transaction to a blockchain network, wherein the boot loader transaction comprises a first signature signing the boot loader and a second signature signing the operating system files, and wherein the boot loader transaction comprises an output locked to a master public key to be used to verify the first and second signatures.

9. The method of claim 8, wherein the first signature is verifiable using the master public key; and
wherein the second signature is verifiable using the master public key.

10. The method of claim 8, wherein the initial boot loader transaction comprises a file address for locating one or more files of the operating system files.

11. The method of claim 8, comprising:
submitting an updated boot loader transaction to the blockchain network, wherein the updated boot loader transaction spends the output of the initial boot loader transaction and comprises an output locked to a respective master public key, wherein the updated boot loader transaction comprises an updated boot loader and/or updated operating system files.

12-13. (canceled)

14. A computer-implemented method of operating a device using a blockchain, wherein the blockchain comprises a first blockchain transaction, the first blockchain transaction comprising first data, wherein a reference to the first blockchain transaction is stored on the device, and wherein the method comprises:
using the reference to obtain the first blockchain transaction; and
operating the device based on the first data, wherein said operating the device comprises one or more of: performing a boot operation; loading a program; updating a program; or updating a software module.

15. The method of claim 14, comprising:
determining that the blockchain comprises a second blockchain transaction that references the first blockchain transaction, wherein the second blockchain transaction comprises second data; and
operating the device based on the second data.

16. The method of claim 15, wherein operating the device comprises booting the device.

17. The method of claim 15, wherein operating the device comprises updating the device.

18. The method of claim 15, wherein the first data and/or the second data is encrypted, and wherein the method comprises decrypting the first data and/or the second data prior to operating the device.

19. The method of claim 14, wherein the reference is stored in hardware of the device.

20-24. (canceled)
